(19) United States
(12) Patent Application Publication
(10) Pub. No.: US 2013/0318900 A1
(43) Pub. Date: Dec. 5, 2013

(54) Grain Bin Floor Support Member

(71) Applicants: Johnny R. Friesen, Winkler (CA); Pedro Giesbrecht, Winkler (CA); Peter W. Friesen, Winkler (CA)

(72) Inventors: Johnny R. Friesen, Winkler (CA); Pedro Giesbrecht, Winkler (CA); Peter W. Friesen, Winkler (CA)

(21) Appl. No.: 13/683,719

(22) Filed: Nov. 21, 2012

(30) Foreign Application Priority Data
Feb. 10, 2012 (CA) 2767936

(51) Int. Cl. F26B 25/10; B65D 88/74

(52) U.S. Cl. CPC F26B 25/10; B65D 88/74
USPC 52/302.2

(57) ABSTRACT

Floor support members in a grain bin floor system support perforated floor panels spanning above a plenum space at the bottom of a grain bin. Each floor support member includes a top rail including a horizontal top flange at a top end of the floor support member and a bottom rail including a horizontal bottom flange at a bottom end of the floor support. Each floor support member further includes a plurality of columns connected between the top rail and the bottom rail such that a top end of each column is abutted with the top flange of the top rail and such that a bottom end of each column is abutted with the bottom flange of the bottom rail. Clinching is used to fasten each column to the top and bottom rails.

This application claims foreign priority benefits from Canadian Patent Application 2,767,936 filed Feb. 10, 2012.

### FIELD OF THE INVENTION

The present invention relates to floor support members in a grain bin floor system for supporting perforated floor panels spanning above a plenum space at the bottom of a grain bin, and more particularly the present invention relates to a grain bin floor support member comprising top and bottom rails connected by a plurality of upright columns.

### BACKGROUND

A floor support structure for grain storage bins for storing wheat, corn, or various other grain type products is described in US Patent Application Publication No. US 2009/0113842 by Grossman et al. The floor support structure is elevated and is used to keep the grain products from contacting a bin floor while creating a plenum between the false floor and the base of the storage bin. Perforations in the false floor permit heated or ambient air located within the plenum to be circulated up through the false floor and into contact with grain supported by the false floor for drying or otherwise conditioning the grain.

The floor support members of US Patent Application Publication No. US 2009/0113842 by Grossman et al are each formed of a single monolithic sheet of material which is cut to define a top rail, a bottom rail and a plurality of upright columns integrally connected therebetween. The columns each comprise a generally c-shaped cross section having a central portion joined integrally with one of the side flanges of the respective top and bottom rails. The side portions of each c-shaped column comprise flanges which rest on a second side flange of each of the respective top and bottom rails. The resulting construction requires heavy gauge material to provide adequate strength due to the weak construction of the center portion being foldable relative to the side flanges of the top and bottom rails integrally joined therewith while the side flanges of the columns concentrate their weight on an intersection of two flange edges.

### SUMMARY OF THE INVENTION

According to one aspect of the invention there is provided a bin floor system for a grain bin, the system comprising:

a plurality of perforated floor panels arranged to fully span a bottom end of the grain bin; and

a plurality of floor support members arranged to support the floor panels thereon so as to define a plenum space below the floor panels, each floor support member comprising:
a top rail including a horizontal top flange at a top end of the floor support member and at least one side flange depending from the top flange along one side thereof;
a bottom rail including a horizontal bottom flange at a bottom end of the floor support member and at least one side flange extending upwardly from the bottom flange along one side thereof; and
a plurality of columns connected between the top rail and the bottom rail such that a top end of each column is abutted with the top flange of the top rail and such that a bottom end of each column is abutted with the bottom flange of the bottom rail, each column being fastened to the side flanges of the top and bottom rails.

By providing columns which span the full height of the floor support member between opposing top and bottom flanges of the top and bottom rails, the full ends of the columns bear weight resulting in a much stronger construction than the prior art.

Each column preferably comprises a channel including a central portion and two side portions extending along opposing sides of the central portion in a generally C-shaped configuration extending vertically between opposing top and bottom edges.

Preferably the top edges of the central portion and the two side portions lie in a common horizontal plane in abutment with the top flange of the top rail and the bottom edges of the central portion and the two side portions lie in a common horizontal plane in abutment with the bottom flange of the bottom rail.

The top rail preferably comprises two side flanges depending from opposing sides of the top flange in which the columns span a full width of the top flange between the two side flanges.

Similarly, the bottom rail preferably comprises two side flanges extending upwardly from opposing sides of the bottom flange in which the columns also span a full width of the bottom flange between the two side flanges.

In the preferred embodiment, each column is fastened to the side flanges by clinching such that a portion of each side flange is punched through and clamps a portion of the column.

One embodiment of the invention will now be described in conjunction with the accompanying drawings in which:

### BRIEF DESCRIPTION OF THE DRAWINGS

FIG. 1 is a perspective view of one of the floor support members of the bin floor system;

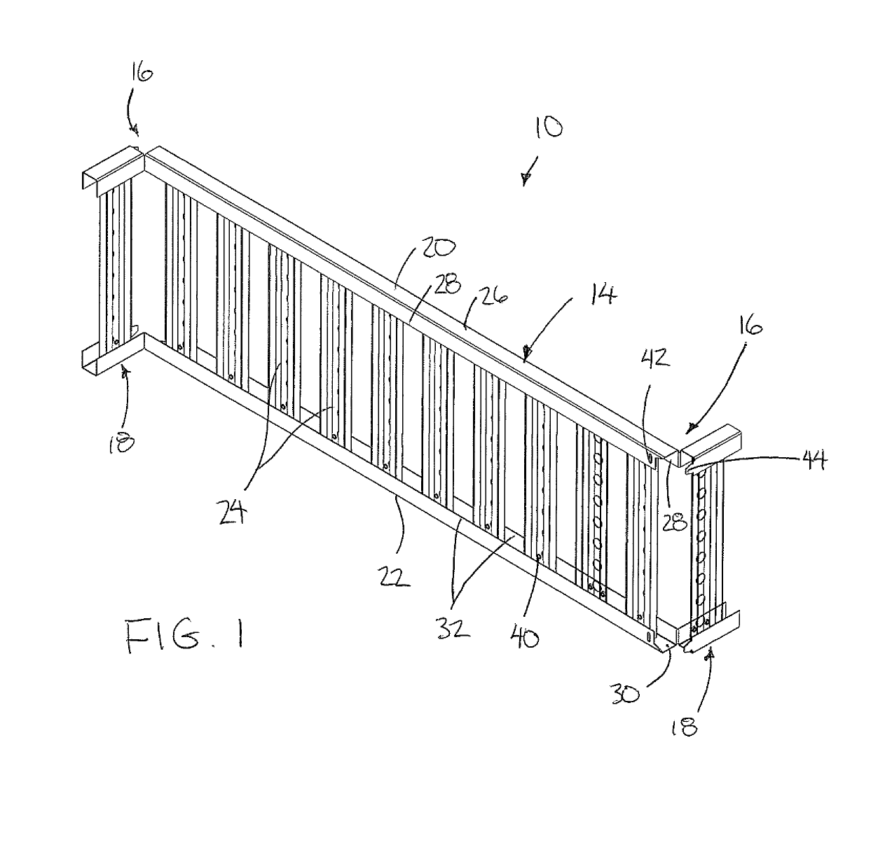

FIG. 2 is a perspective view of two floor support members abutted end to end;

FIG. 3 is a side elevational view of one floor support member;

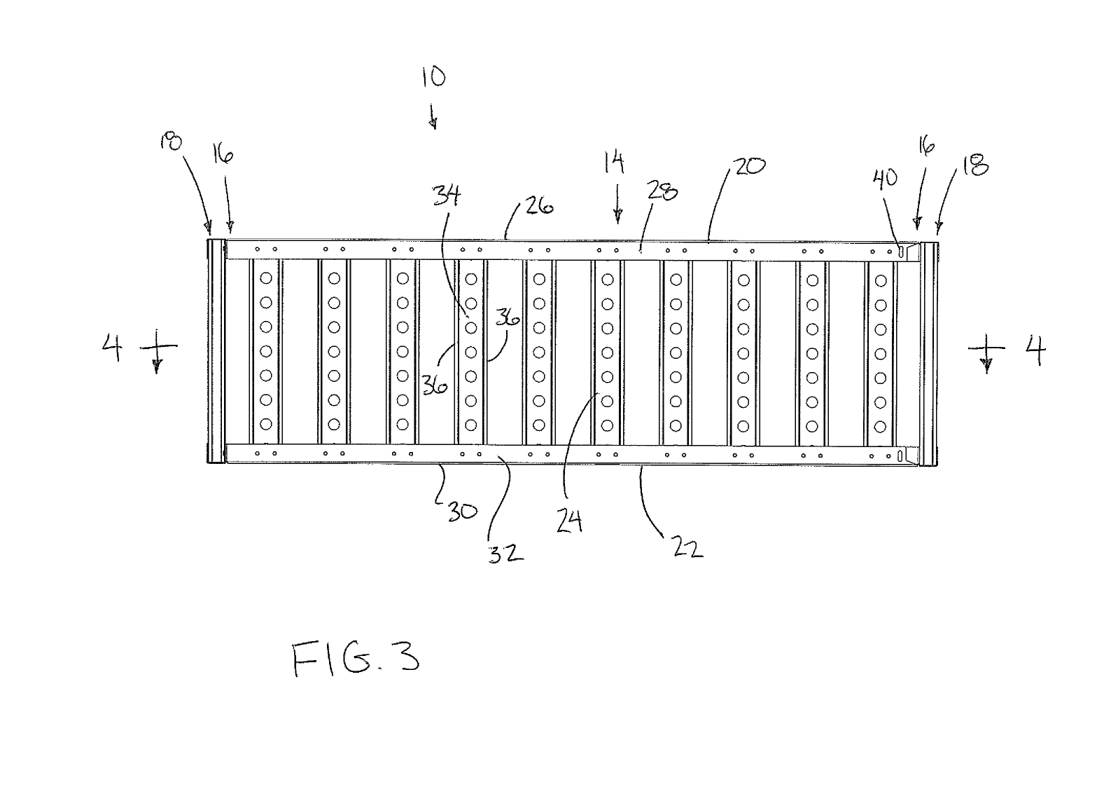

FIG. 4 is a sectional view along the line 4-4 of FIG. 3;

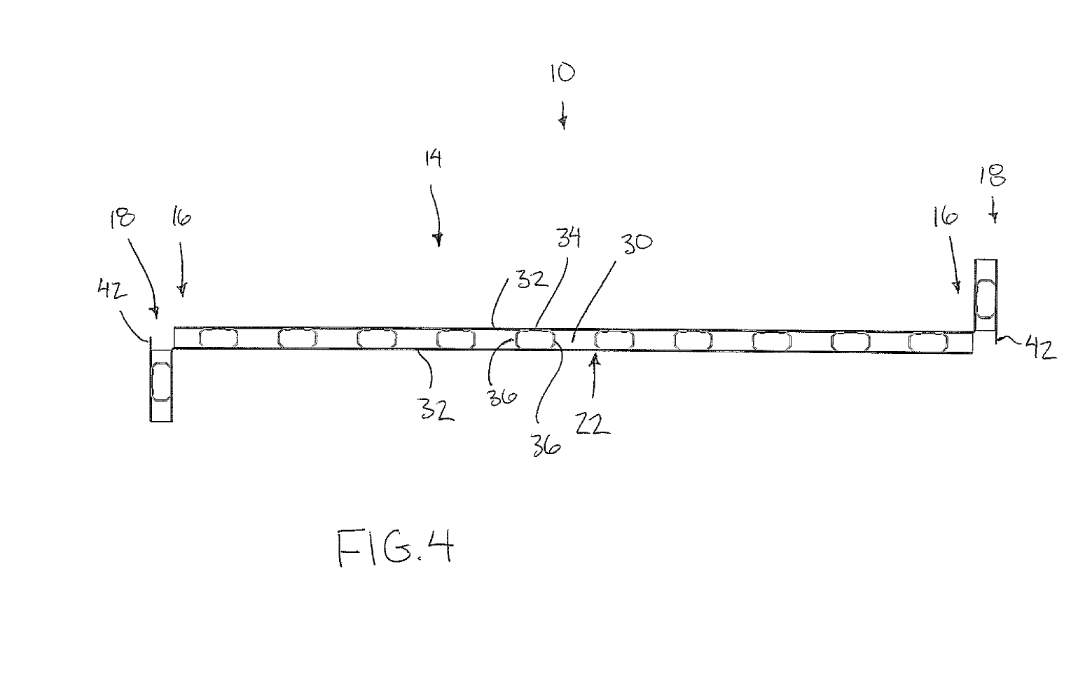

FIG. 5 is an end elevational view of one floor support member; and

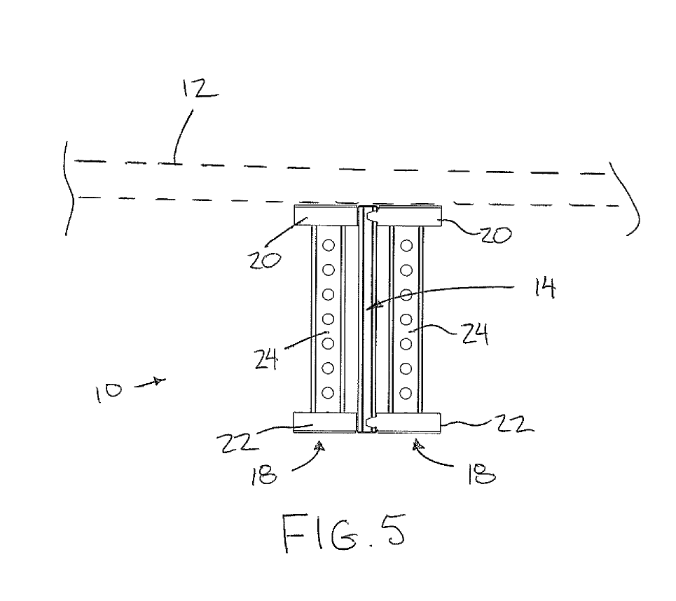

FIG. 6 is an enlarged sectional view of one end of FIG. 4.

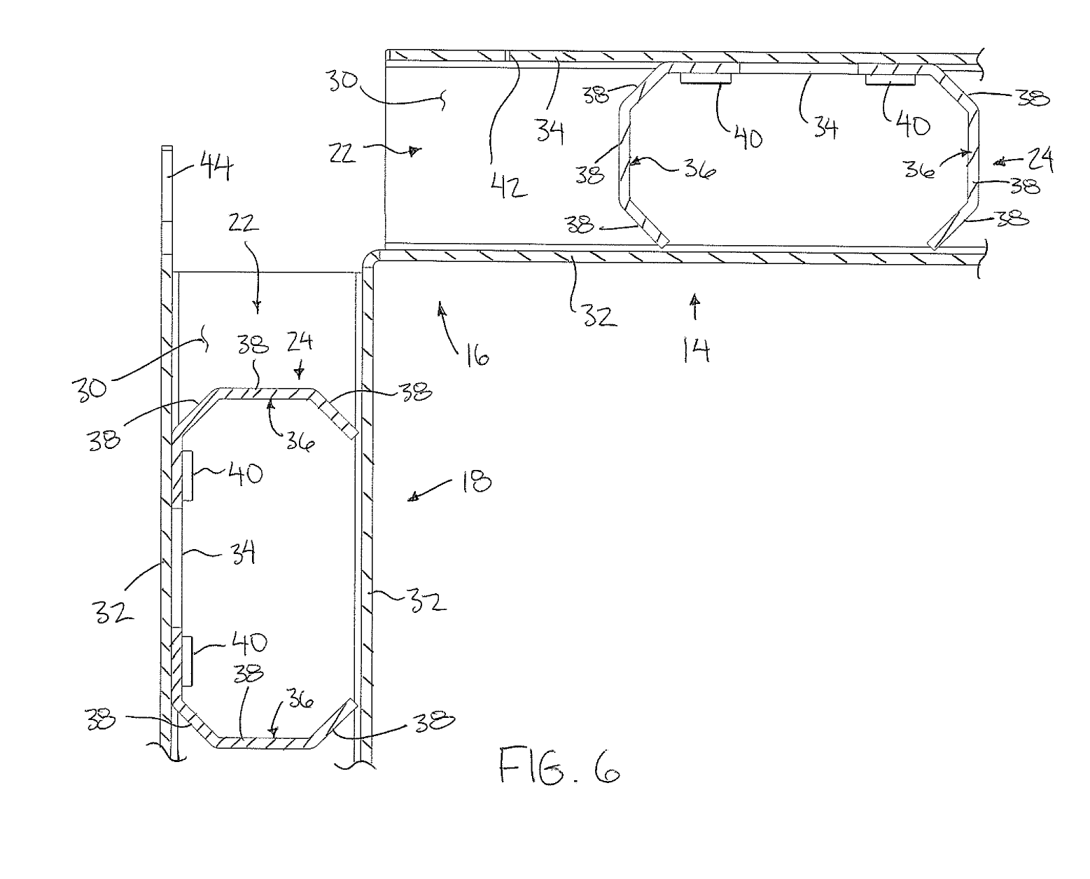

In the drawings like characters of reference indicate corresponding parts in the different figures.

### DETAILED DESCRIPTION

Referring to the accompanying figures there is illustrated a floor support member generally indicated by reference numeral 10. The support member 10 is particularly suited for use in supporting floor panels 12 in a grain bin floor system.

Typically, the perforated floor panels 12 are elongate so as to span in a lateral direction in an end-to-end configuration and side by side one another to fully span the bottom end of a grain bin. The support members 10 are similarly elongate between opposing ends such that each support member spans in a longitudinal direction perpendicularly to the elongate direction of the floor panels 12 thereabove.

The support members 10 are supported in an end-to-end configuration in rows which are parallel and spaced apart from one another on a suitable foundation. Each floor panel 12 spans over a plurality of rows of support members when forming the floor. The support members support the floor panels thereon so as to define a plenum space below the floor and above the foundation for circulating air up from the plenum space through the perforations in the floor panels and through grain supported in the bin for grain aeration.

Each floor support member includes a main portion 14 spanning a full height of the floor support member and spanning in a longitudinal direction between the two opposed ends 16 of the member. Each support member 10 further includes two end portions 18 joined to respective opposing ends 16 of the main portion. Each end portion also spans a full height of the support member but is oriented in a lateral direction perpendicular to the longitudinal direction of the main portion. The two end portions extend outwardly in opposing directions from a common vertical plane of the main portion such that the floor support member is generally Z-shaped in plan view.

Each of the main and end portions of the support member includes a top rail 20, a bottom rail 22, and one or more columns 24 connected vertically between the top and bottom rails.

Each top rail 20 is generally U-shaped in configuration comprising a horizontal top flange 26 and two side flanges 28 extending along opposing sides of the top flange along the full length thereof to depend vertically downward therefrom. Similarly, the bottom rail is a generally U-shaped channel comprising a horizontal bottom flange 30 supporting two side flanges 32 extending along opposing sides thereof along the full length of the bottom flange to extend vertically upward therefrom parallel and spaced apart from one another.

Each column 24 is a generally C-shaped channel comprising a central portion 34 formed of a single upright flange in abutment against one of the side flanges of each of the top and bottom rails as well as two side portions 36 along opposing sides of the central portion. Each of the side portions comprises three flanges 38 joined by respective vertical folds such that the middle ones of the two side portions are parallel and define opposing sides of the column.

The top edges of all of the flanges of each column lie in a common horizontal plane in direct abutment with the top flange of the top rail. Similarly, the bottom edges of all of the flanges of each column lie in a common horizontal plane in direct abutment with the bottom flange of the bottom rail.

The side portions 36 of each column are arranged to span a full width between the two side flanges of each of the top and bottom rails when the central portions of the columns are abutted along an inner side of a respective side flange of the top and bottom rails. The columns are oriented such that the central portions are all abutted along a common one of the side flanges of the top and bottom rails.

Each column is fastened to each rail at two longitudinally spaced locations at the overlap of the central portion with the respective side flange. Fastening is accomplished by clinching in which a tool punches a portion 40 of the side flange through an aperture in the central portion of the respective column where the punched portion 40 is then flattened against the opposing side of the central portion of the column for clamping a portion of the column between the punched portion 40 and the remainder of the side wall of the respective rail.

Each end portion is joined to the respective end of the main portion by forming all of the top rails as one integral channel which has been cut such that only one side flange of each of the top and bottom rails is connected to a corresponding adjacent one of the side flanges of the respective top and bottom rails of the main portion. The end portions are thus foldable from a transport position lying in a common plane with the main portion to a working position oriented perpendicularly to the main portion.

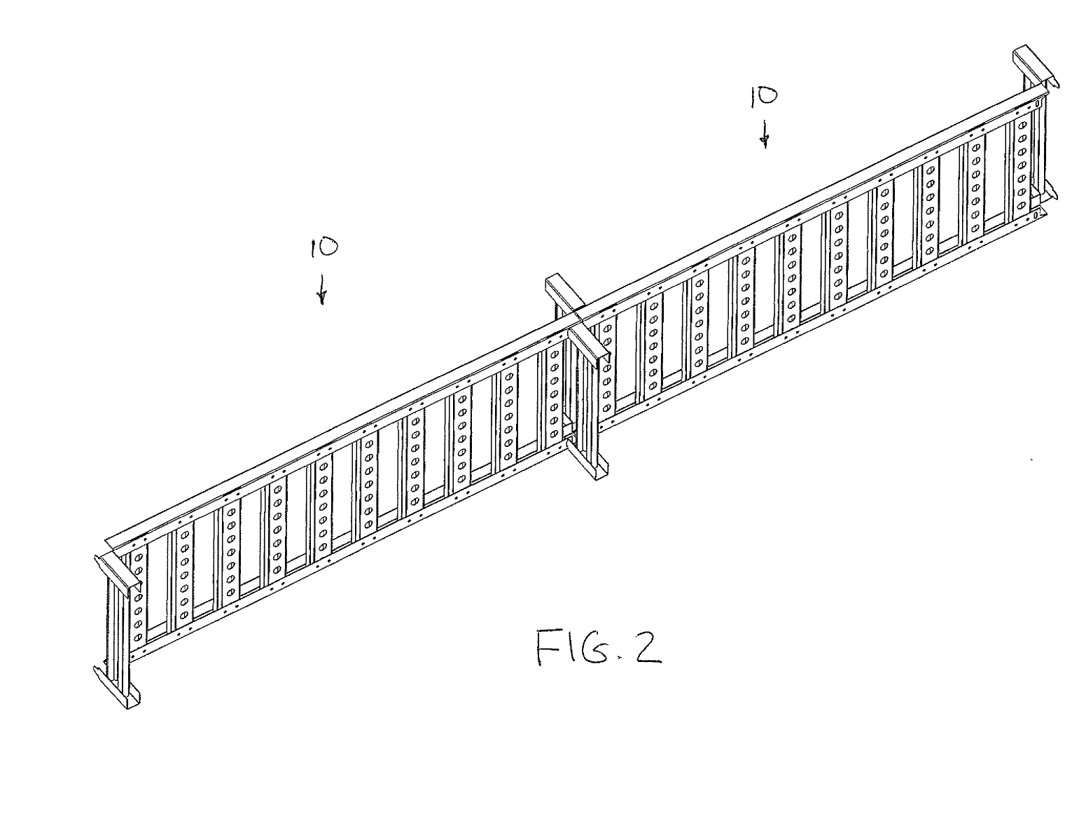

At each of the opposed ends of the main portion, the side flange not directly coupled to the adjacent end portion locates an aperture 42 thereon. The corresponding side flange of the top and bottom rails of the end portions include tabs 44 formed thereon. In this instance, when the main portions of two adjacent floor support members are abutted end-to-end with one another in a generally common vertical plane, the tabs of each end portion are arranged to be received within the corresponding apertures in the main portion of the other support member to couple the two support members in the end-to-end abutted relationship shown in FIG. 2. In this mounted position at each abutted junction of two support members, one of the end portions extends laterally outward from the main portions in the opposing lateral direction from the other end portion.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A bin floor system for a grain bin, the system comprising:
a plurality of perforated floor panels arranged to fully span a bottom end of the grain bin; and
a plurality of floor support members arranged to support the floor panels thereon so as to define a plenum space below the floor panels, each floor support member comprising:
a top rail including a horizontal top flange at a top end of the floor support member and at least one side flange depending from the top flange along one side thereof;
a bottom rail including a horizontal bottom flange at a bottom end of the floor support member and at least one side flange extending upwardly from the bottom flange along one side thereof; and
a plurality of columns connected between the top rail and the bottom rail such that a top end of each column is abutted with the top flange of the top rail and such that a bottom end of each column is abutted with the bottom flange of the bottom rail, each column being fastened to the side flanges of the top and bottom rails.

2. The bin floor system according to claim 1 wherein each column comprises a channel including a central portion and two side portions extending along opposing sides of the central portion in a generally C-shaped configuration extending vertically between opposing top and bottom edges, the top edges of the central portion and the two side portions lying in a common horizontal plane in abutment with the top flange of the top rail and the bottom edges of the central portion and the two side portions lying in a common horizontal plane in abutment with the bottom flange of the bottom rail.

3. The bin floor system according to claim 2 wherein the top rail comprises two side flanges depending from opposing sides of the top flange, the columns spanning a full width of the top flange between the two side flanges.

4. The bin floor system according to claim 2 wherein the bottom rail comprises two side flanges extending upwardly from opposing sides of the bottom flange, the columns spanning a full width of the bottom flange between the two side flanges.

5. The bin floor according to claim 1 wherein each column is fastened to the side flanges by clinching such that a portion of each side flange is punched through and clamps a portion of the column.
